(19) United States
(12) Patent Application Publication
(10) Pub. No.: US 2010/0052205 A1
(43) Pub. Date: Mar. 4, 2010

(54) Method of forming ceramic honeycomb substrates

(76) Inventors: Thomas William Brew, Corning, NY (US); Rudy Paul Ellis, Painted Post, NY (US); Susan Clair Lauderdale, Painted Post, NY (US); Michael James Lehman, Canisteo, NY (US)

Correspondence Address: CORNING INCORPORATED, SP-TI-3-1, CORNING, NY, 14831, US

(21) Appl. No.: 12/411,608

(22) Filed: Mar. 26, 2009

Related U.S. Application Data
(60) Provisional application No. 61/092,272, filed on Aug. 27, 2008.

(51) Int. Cl. B29C 47/26; B29C 47/00

(52) U.S. Cl. 264/177.12; 425/463

(57) ABSTRACT

Methods and apparatus for manufacturing strengthened ceramic honeycomb articles having thickened peripheral web segments by extruding, drying and firing honeycomb shapes formed by the extrusion of plasticized ceramic powder batches through honeycomb extrusion dies having peripheral slots incorporating outer widened slot portions of controlled depths, the controlled depths being selected to increase ceramic powder batch flow through the peripheral slots to a degree sufficient to form the thickened web segments but insufficient to cause geometric distortion of the thickened web segments.

### CROSS-REFERENCE TO RELATED APPLICATIONS

This application claims the benefit of priority to U.S. provisional application No. 61/092,272, filed on Aug. 27, 2008.

### BACKGROUND

1. Field of Invention

The present invention is in the field of ceramic honeycomb manufacture and more particularly relates to the manufacture of ceramic honeycomb substrates of improved strength for applications such as the support of catalysts in combustion engine exhaust systems.

2. Technical Background

The use of cellular ceramic honeycomb substrates for the catalytic treatment of motor vehicle exhaust gases to remove unburned hydrocarbons, carbon monoxide and nitrogen oxides therefrom is well known. Such honeycomb substrates, which are most commonly produced by the extrusion of plasticized ceramic batch mixtures from honeycomb extrusion dies, conventionally comprise an array of parallel cells or channels bounded by thin ceramic walls or webs that are coated with catalysts effective for the treatment of these exhaust gasses.

As exhaust emissions limits have become more stringent, designs for ceramic catalyst support honeycomb substrates have trended toward lower cell densities and reduced web thicknesses to provide lower exhaust system pressure drops in combination with more rapid catalyst light-off response. Absent corrective action, these changes would have resulted in an overall weaker structure and reduced mechanical durability for the honeycomb substrates, rendering them less able to withstand the mechanical and thermal stresses of the exhaust system environment.

Among the design changes adopted to enhance substrate durability have been compositional and/or geometric modifications to the periphery of the substrates to improve peripheral strength. Some embodiments of peripheral strengthening have included selective thickening of the peripheral web structure and/or skins of the substrates.

U.S. Pat. No. 4,233,351 shows one approach to peripheral web thickening. These and similar peripherally thickened honeycomb structures are typically formed by extrusion through ceramic honeycomb dies wherein the discharge slots forming peripheral webs are widened to increase the wall thicknesses of the peripheral webs. However, the strength enhancements resulting from such web thickening have been erratic and generally lower than would have been expected from strength analyses of the modified geometries. In a number of cases, the erratic strength results appear to be related to geometric distortions of the peripheral web structures, arising during the initial extrusion of the substrates rather than in the course of subsequent drying and firing of the extruded honeycomb shapes. Thus room for improvement of the realized strengths of peripherally strengthened ceramic honeycomb substrates remain.

### SUMMARY

Broadly characterized, the present invention addresses the issue of inadequate peripheral strength by reducing geometric web distortions that can arise during the extrusion of peripherally thickened honeycomb substrates. These results are achieved through extrusion die modifications that directly address an important cause of these distortions. Those modifications particularly include modifications to the widened discharge slots through which the thickened peripheral web structures are formed, these modifications being carried out in a manner that controls extrusion rates through the peripheral slots to control web distortions, but still maintains the required increases in peripheral web thickness.

In a first aspect, therefore, embodiments according to the present invention provide an improved method for manufacturing a ceramic honeycomb article having a strengthened peripheral web structure. The method follows the known method of compounding and plasticizing a mixture comprising oxide ceramic powders and a liquid vehicle to form a plasticized ceramic powder batch, extruding the ceramic powder batch through a honeycomb extrusion die to form a green ceramic honeycomb shape, and drying and firing the green ceramic honeycomb shape to form the ceramic honeycomb article. Extrusion is through the discharge slots of a conventionally set depth in the discharge face of the extrusion die, with peripheral discharge slots being widened to provide an extruded honeycomb shape with peripheral channels bounded by thickened web segments.

In accordance with the invention, the thickened web segments are extruded from peripheral slots having widened outer slot portions that extend into the discharge face for a controlled depth. According to certain embodiments of the invention, that controlled depth is selected to increase ceramic powder batch flow to a degree sufficient to form the thickened web segments, but insufficient to cause geometric distortion of said thickened web segments. In some embodiments the controlled depth will be up to but less than one-half of the set depth of the non-peripheral discharge slots forming the interior (non-thickened) webs of the extruded honeycomb shape, but at least 4 times the width of the widened outer slot portions.

In another aspect, embodiments according to the invention include a method for manufacturing a ceramic honeycomb article having a strengthened peripheral web structure through the steps of compounding and plasticizing a ceramic batch mixture comprising oxide ceramic powders and a liquid vehicle, extruding the batch mixture through a die to form a green ceramic honeycomb shape, and drying and firing the honeycomb shape as above described. Extruding of the green honeycomb shape is carried out through discharge slots of a set depth in the discharge face of a honeycomb extrusion die, with the extruded shape comprising peripheral channels bounded by thickened web segments that are discharged from peripheral slots of the extrusion die having widened outer slot portions.

The peripheral slots of the extrusion die incorporate widened outer slot portions having selected widths for forming thickened webs of a selected thickness, including widened slot portions of widest width for forming the thickest web segments. The thickest web segments form the outermost channels in a number of advanced honeycomb designs incorporating strengthened peripheral web structures. According to embodiments of the present invention, however, the widened outer slot portions will extend into the discharge face of the die for controlled depths, with the controlled depths being selected to be deep enough to increase the flow of the ceramic powder batch through the slot portions of widest width to a degree providing thickened webs that are fully integral yet substantially free of geometric distortion. Thus the thickest webs, as well as the other webs in the strengthened peripheral web structure, will be free of web discontinuities, and also free of geometric distortions caused by differences in batch flow across the discharge face of the die.

In yet another aspect, the invention may be seen to reside in a ceramic honeycomb die of improved design for the production of peripherally thickened ceramic honeycomb substrates of improved strength. The improved extrusion die incorporates conventional features including a die body having an inlet face provided with a plurality of feedholes for admitting a plasticized ceramic powder batch into the die body and a plurality of discharge slots of a set depth connecting with the feedholes and opening onto a discharge face of the die. The discharge slots are arranged to discharge the plasticized ceramic powder batch from the die in the form of a green ceramic honeycomb shape, with selected slots in a peripheral region of the discharge face having widened slot portions of a selected width for the extrusion of thickened peripheral webs. However, the widened slot portions extend into the die body only for a controlled depth, that depth being up to but less than one half of the set depth. In certain embodiments, web integrity will be improved if the controlled depth is at least 4 times the selected width of those widened slot portions.

Still other aspects of the invention will become apparent from embodiments thereof set forth in the following detailed description and drawings, which embodiments are, however, intended to be illustrative rather than limiting.

### BRIEF DESCRIPTION OF THE DRAWINGS

The invention is further described below with reference to the appended drawings, wherein:

FIG. 1 presents a schematic partial cross-sectional elevational view of a conventional honeycomb die showing widened slots in a peripheral section of the die;

FIG. 2 is a plan view of a section of an extruded honeycomb shape showing geometric distortion in some webs;

FIG. 3 presents partial cross-sectional views of honeycomb extrusion dies incorporating widened peripheral slots of controlled depth; and

FIG. 4 illustrates the effects of depth control of slot widening on the extrusion speeds of peripheral webs extruded from partially widened slots.

### DETAILED DESCRIPTION

Referring more particularly to the drawings, FIG. 1 presents a partial schematic elevational cross-section of a ceramic honeycomb extrusion die of known design, not in true proportion or to scale, as conventionally modified to extrude green honeycomb shapes with thickened peripheral webs. As shown in FIG. 1, extrusion die 10, typically formed of a high strength material such as stainless steel, includes a die body 12 provided with feedholes 14 into which a plasticized ceramic batch material 16 is introduced into the die. Connecting with feedholes 14 are discharge slots 18 terminating on a discharge face 20 of the die from which the plasticized batch material 16 is discharged in the form of a green honeycomb shape 30 having an outer extruded skin 36 surrounding the shape and adhering to peripheral webs 32.

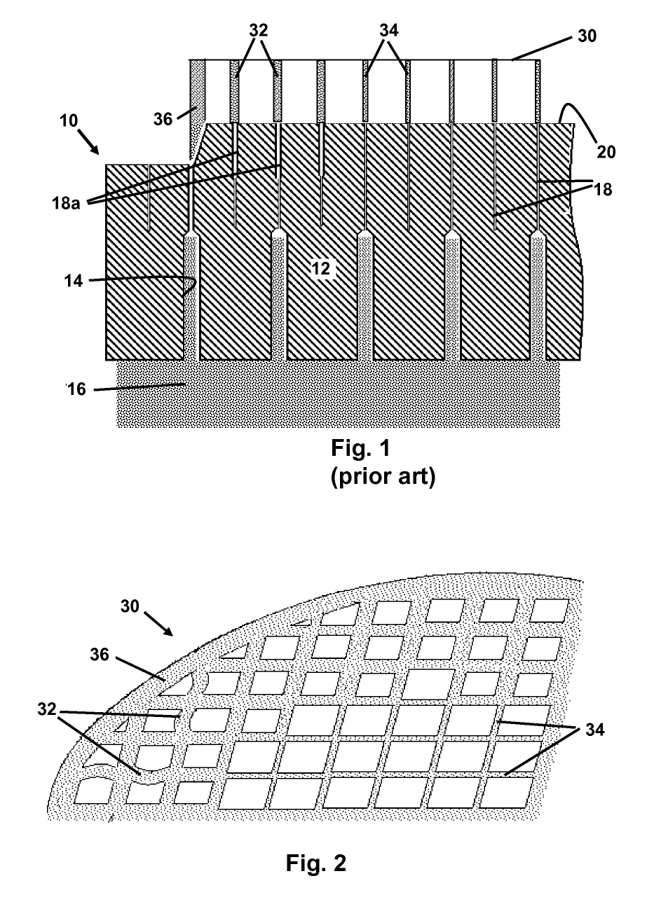

For the purpose of producing stronger peripheral webs 32 having greater thickness than interior webs 34, widened peripheral discharge slots 18a are provided. Slot widening is conventionally accomplished by plunge EDM machining with a tab electrode of a suitable width. As expected, the result of this slot widening is a thickened peripheral web intended to impart added strength to the dried and fired honeycomb structure. An unintended result, however, can be distortion of the thickened peripheral webs, such distortion interfering with the desired strengthening and in some case reducing the strength of the fired honeycombs. FIG. 2 of the drawing is a top plan view of a section of a honeycomb shape 30 showing deformation of peripheral webs 32.

We have identified differential extrusion speed as a principal cause of peripheral web distortion. That is, the linear speed at which plasticized ceramic powder batch material 16 issues from the discharge slots 18 on the face 20 of the extrusion die 10 is not uniform, the differential between the extrusion speed from widened peripheral slots 18a and non-widened interior slots being so great as to cause distortion of the peripheral webs 32.

Observations and calculations of extrusion speeds from peripheral and interior slots have confirmed a strong correlation between the magnitude of the extrusion speed differentials and the risk of peripheral web distortion. Table 1 below correlates ranges of extrusion velocity differential ranges, reported as Velocity Deltas, against the risk of peripheral web deformation (Defect Risk) as determined by the appearance of web defects observed in extruded parts under various extrusion conditions. At the minimal deformation risk level, no distortion of the peripheral web structure of extruded parts is visually detectable even over prolonged production runs, whereas at high deformation risk levels, few or no extruded parts are completely free of such distortion.

TABLE 1

| Velocity Delta | Defect Risk |
|---|---|
| 0-7% | minimal deformation risk |
| 7-10% | low deformation risk |
| 10-20% | moderate deformation risk |
| >20% | high deformation risk |

Based on the above findings it is concluded that the extrusion of peripherally strengthened honeycomb articles is best carried out under conditions wherein the controlled depth of the widened portions of the peripheral slots in the extrusion dies employed is maintained at a value that will be insufficient to increase the axial flow velocity of the ceramic powder batch being extruded from those slots to a level that is more than 20% in excess of the lower axial flow velocity from interior die slots that do not incorporate widened outer slot portions.

A traditional approach toward balancing flow speeds across the face of honeycomb extrusion dies has been to utilize flow control hardware behind the die, i.e., between the die and batch conditioning screens at the extruder outlet. Such hardware can control the flow rate of batch into the die inlet feedholes, thus controlling extrusion speeds at the face of the die. However, this approach to flow balancing adds considerable cost and complexity to the extrusion process, and is generally to be avoided.

We have determined that the observed flow velocity deltas arise as the result of differences in flow impedance as between peripheral and interior slots. That is, we associate the excessively high extrusion velocity differentials and resulting defects in peripheral web shape to unduly low impedance in the widened peripheral slots 18a. We have further determined that, by controlling the depth of slot widening in the peripheral slots, the speed of batch flow from those slots may be controlled to reduce these differentials, and thereby eliminate a principal cause of peripheral web distortion.

Controlling these depths also aids in the production of honeycomb shapes incorporating outer extruded skins adhering to the outermost thickened web segments, including shapes with strengthening fillets at the junctions of the thickened web segments and skins. Reducing the depth of widening in the outermost ring of slots helps to control extrusion speed differentials at the junctions between those slots and the skin-forming slot, thereby achieving better control over the formation of such extruded fillets.

The depth of the widened slot portions most effective for minimizing peripheral web distortion while still insuring good web integrity will depend in part on the particular design of the honeycomb extrusion die to be employed, but in any case may be readily determined by pressure drop calculations and/or routine experiment. Equations useful for calculating pressure drop differentials through extrusion dies of known feedhole and discharge slot geometry are well known, published United States patent application No. US 2006-0178769 providing examples of such equations. While not necessary for the practice of the invention, such calculations are useful for ascertaining initial ranges of widened slot depth most likely to provide optimal results.

Table 2 below sets forth calculated extrusion speed values for a model ceramic powder extrudate discharged from the interior and widened peripheral slots of three honeycomb extrusion dies, identified as Gen I, Gen II, and Gen III. The dies are of conventional design, all having interior slots of (0.0036 inches) width and (0.130 inches) depth. The data presented in Table 2 include extrusion speed (V) data for the interior and peripheral slots of each die at each of five different peripheral slot widths, the three dies differing as to the depths (D) of the widened slot portions of those peripheral slots. Extrusion speed differentials (ΔV) as between the interior slots and the widened peripheral slots are also reported. The extrusion pressure used as basis for generating the data is at a level providing an extrusion velocity of (2.10 inches/sec) through the interior slots of each of the dies.

TABLE 2
Extrusion Speed Differentials

| | Widened Slot Portion | | | | | |
|---|---|---|---|---|---|---|
| | Depths (D) | | | | | |
| Widened | Gen I Die | | | | | |
| Slot | D = 0.065 | | | | | |
| Portion | inches | | Gen II Die | | Gen III Die | |
| Widths | V | | D = 0.045 inches | | D = 0.030 inches | |
| (inches) | (in/sec) | ΔV (%) | V (in/sec) | ΔV (%) | V (in/sec) | ΔV (%) |
| 0.0036 | 2.10 | 0.00% | 2.10 | 0.00% | 2.10 | 0.00% |
| 0.0041 | 2.29 | 8.88% | 2.23 | 6.02% | 2.18 | 3.95% |
| 0.0046 | 2.45 | 16.73% | 2.33 | 11.13% | 2.25 | 7.21% |
| 0.0051 | 2.60 | 23.71% | 2.43 | 15.53% | 2.31 | 9.95% |
| 0.0056 | 2.73 | 29.94% | 2.51 | 19.36% | 2.36 | 12.29% |
| 0.0061 | 2.85 | 35.55% | 2.58 | 22.71% | 2.4 | 14.30% |

As the data in Table 2 suggest, widened slot portions of 0.065 inches depth (on the order of one-half the interior slot depth of 0.130 inches) as present in the Gen I Die produce extrusion speed differentials above 20% at slot widths as low as 0.0051 inches in this particular die design. Table 1 above indicates that extrusion speed differentials above 20% carry a high risk of peripheral web distortion. Thus the Gen I die would produce extruded honeycomb shapes with significant peripheral web distortion at the higher peripheral web thicknesses, absent other measures taken to correct the large extrudate flow speed imbalance. In contrast, data for the Gen III die with widened slot portions of 0.030 inches depth indicates that extrusion speed differentials are maintained below 20% at all slot widths evaluated.

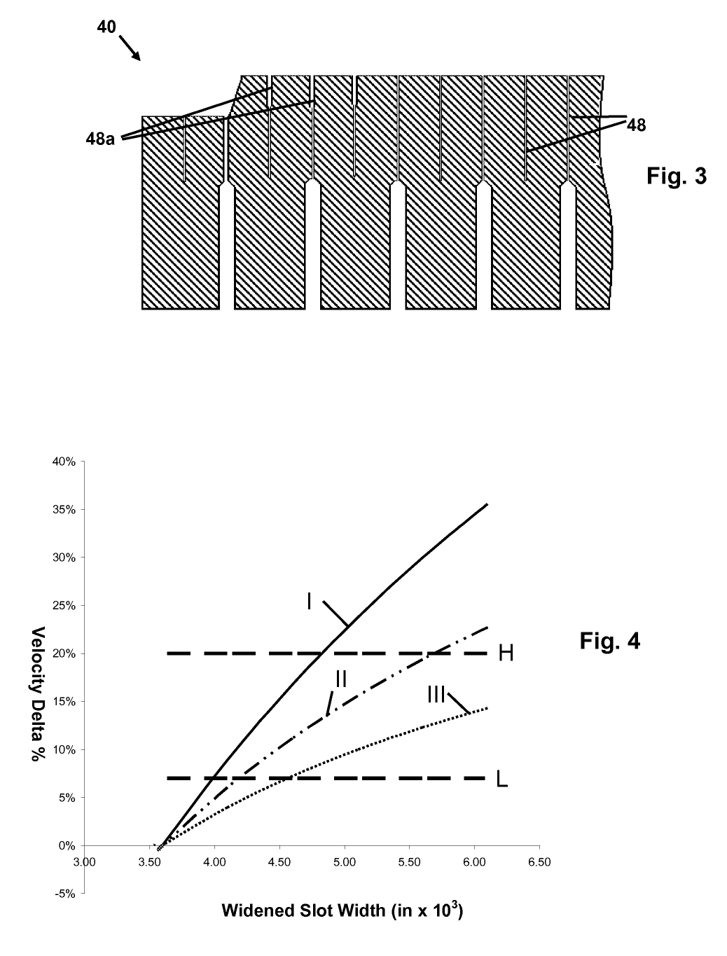

FIG. 3 of the drawings provides a schematic elevational cross-sectional view of a portion of a honeycomb extrusion die 40 of a configuration like that of the Gen III die, showing reduced depths for the widened slot portions 48a of the die as compared with the depths of interior slots 48. FIG. 4 presents curves plotting calculated flow speed (velocity) differentials as a function of widened peripheral slot widths across the discharge faces of three honeycomb dies. The curves designated I, II and III in FIG. 4 present velocity differential data for dies with geometric configurations generally corresponding respectively to the Gen I, Gen II and Gen III dies of Table 2. Those curves clearly reflect both the direct relationship between slot width and extrusion speed and the beneficial effect of widened slot depth reductions on the magnitudes of the differentials observed.

Also indicated in FIG. 4 are the threshold velocity differential levels L and H, the L level corresponding to a low risk of peripheral web distortion and the H level corresponding to a high risk of distortion as reported Table I. The much wider range of peripheral slot widths that can be utilized in the die design of curve III without encountering a high risk of web distortion is apparent from an analysis of these curves.

Although depth reductions for the widened slot portions of peripheral extrusion die slots have proven quite effective for the reduction of peripheral web distortion in peripherally strengthened honeycomb articles, such depths cannot be reduced without limit. If the depth reductions are too great, the integrity of the thickened peripheral webs of the extruded honeycomb shapes can be compromised. In general the minimum controlled depth for insuring integral thickened web segments, i.e., thickened web segments that are substantially free of web discontinuities, has been found to correspond to a depth of about 4 times the maximum slot width of the widened slot portions.

Advanced designs for peripherally strengthened honeycombs typically incorporate thickened peripheral webs over a range of thicknesses, made from extrusion dies incorporating widened outer slot portions covering a range of widths ranging from relatively slight widening adjacent the interior slots of the die to slot portions of widest width adjacent the extruded skins of the honeycombs. Thickened webs formed by the slot portions of widest width are most prone to geometric distortion.

Based on analyses of data such as reported in Table 2 and FIG. 4, above, the use of widened peripheral slots wherein the controlled depth of the widened outer slot portions of widest width is in the range of about 4-10 times that widest width generally provide good protection from both web distortion and web discontinuities. Strengthened thin-walled honeycomb substrates can be efficiently produced with a very low risk of thickened peripheral web distortion utilizing extrusion dies having interior slot widths of 0.003-0.004 inches and widened outer slot portions in the width range of about 0.0035-0.0065 inches, if the peripheral slots of widest width are within the aforementioned range of controlled depth.

The above-described methods and apparatus can be used with particular advantage in the production of strengthened honeycomb products such as disclosed in published international patent application WO 2004-073969, e.g., products wherein peripheral channels with thickened web segments are disposed over at least three outer channel rows extending inwardly from the honeycomb periphery toward a central axis of the green honeycomb shape. Honeycombs comprising from three to six outer channel rows can provide excellent strength enhancement in the resulting fired honeycombs. Further, the production of ceramic honeycomb shapes wherein extruded fillets are provided at junctions between the extruded skin of the honeycombs and the outermost thickened web segments is considerably facilitated.

The production of peripherally strengthened honeycombs free of peripheral web distortion in accordance with the above methods offers substantial economic advantages in terms of improved product selection rates and reduced process complexity. That is because plasticized ceramic powder batch mixtures may be delivered directly from extruders to honeycomb extrusion dies such as above described without the need to force the batch material to traverse supplemental peripheral flow throttling apparatus interposed between the extruders and dies.

While the foregoing invention has been described above with respect to specific illustrative examples and embodiments, it will be apparent that various modifications and adaptations of those embodiments may be made to meet the requirements of particular applications within the scope of the appended claims.

We claim:

1. A method for manufacturing a ceramic honeycomb article having a strengthened peripheral web structure comprising the steps of:
compounding and plasticizing a mixture comprising oxide ceramic powders and a liquid vehicle to form a plasticized ceramic powder batch;
extruding the ceramic powder batch through slots of a set depth in a discharge face of a honeycomb extrusion die to form a green ceramic honeycomb shape having peripheral channels bounded by thickened web segments; and
drying and firing the green ceramic honeycomb shape to form the ceramic honeycomb article;
wherein the thickened web segments are extruded from slots having widened outer slot portions extending into the discharge face for a controlled depth that is selected to increase ceramic powder batch flow to a degree sufficient to form the thickened web segments but insufficient to cause geometric distortion of said thickened web segments.

2. A method in accordance with claim 1 wherein the controlled depth is insufficient to increase an axial flow velocity of ceramic powder batch being discharged from the widened outer slot portions to a level that is more than 20% in excess of a lower axial flow velocity of ceramic powder batch being discharged from slots absent the widened outer slot portions.

3. A method in accordance with claim 2 wherein the controlled depth is up to but less than one-half of the set depth.

4. A method for manufacturing a ceramic honeycomb article having a strengthened peripheral web structure comprising the steps of:
compounding and plasticizing a mixture comprising oxide ceramic powders and a liquid vehicle to form a plasticized ceramic powder batch;
extruding the ceramic powder batch through discharge slots of a set depth in a discharge face of a honeycomb extrusion die to form a green ceramic honeycomb shape having peripheral channels bounded by thickened web segments; and
drying and firing the green ceramic honeycomb shape to form the ceramic honeycomb article; wherein:
(i) the thickened web segments are extruded from slots having widened outer slot portions of selected widths, including thickest web segments extruded from slot portions of widest width;
(ii) the widened outer slot portions extend into the discharge face for a controlled depth, and
(iii) the controlled depth is selected to increase a flow of the ceramic powder batch through the slot portions of widest width to a degree providing thickest web segments that are integral but substantially free of geometric distortion.

5. A method in accordance with claim 4 wherein the controlled depth is in the range of about 4-10 times the width of the widened outer slot portions of widest width.

6. A method in accordance with claim 4 wherein the widened outer slot portions have selected widths in the range of 0.0035-0.0065 inches.

7. A method in accordance with claim 4 wherein the peripheral channels bounded by thickened web segments are disposed over at least three channel rows extending inwardly toward a central axis of the green ceramic honeycomb shape.

8. A method in accordance with claim 4 wherein the plasticized ceramic powder batch is delivered directly from the output of an extruder to the honeycomb die without traversing supplemental peripheral flow throttling apparatus.

9. A method in accordance with claim 4 wherein the green ceramic honeycomb shape comprises an outer extruded skin adhering to selected thickened web segments, and wherein extruded fillets are provided at junctions between the skin and the selected thickened web segments.

10. A ceramic honeycomb extrusion die having a die body incorporating an inlet face provided with a plurality of feedholes for admitting a plasticized ceramic powder batch into the die body and a plurality of discharge slots of a set depth connecting with the feedholes and opening onto a discharge face of the die, said slots being arranged to discharge the plasticized ceramic powder batch from the die in the form of a green ceramic honeycomb shape,
wherein selected slots in a peripheral region of the discharge face have widened slot portions of a selected width that extend into the die body for a controlled depth, the controlled depth being less than one-half the set depth but at least 4 times the selected width.

11. An extrusion die in accordance with claim 10 wherein the controlled depth is in the range of 4-10 times the selected width.

12. An extrusion die in accordance with claim 11 wherein the widened slot portions have selected widths in the range of 0.0035-0.0065 inches.
